(19) United States
(12) Patent Application Publication
(10) Pub. No.: US 2016/0321938 A1
(43) Pub. Date: Nov. 3, 2016

(54) UTILIZING TEST-SUITE MINIMIZATION FOR EXAMINATION CREATION

(71) Applicant: International Business Machines Corporation, Armonk, NY (US)

(72) Inventors: Pavel Kisilev, Maalot (IL); Eugene Walach, Haifa (IL); Aviad Zlotnick, Mitzpeh Netofah (IL)

(21) Appl. No.: 14/698,884

(22) Filed: Apr. 29, 2015

(51) Int. Cl. G09B 7/02

(52) U.S. Cl. CPC G09B 7/02

(57) ABSTRACT

Methods, computing systems and computer program products implement embodiments of the present invention that include defining a first number of categories, each of the categories having a respective second number of values, and assigning, to each given examination question in a set of examination questions, a respective third number of categories and at least one given value for each of the third number of categories. A a set of requirements is retrieved, each given requirement including a respective fourth number of category requirements and a respective value-requirement for each of the category requirements, and a test-suite minimization algorithm is executed in order to select a minimum subset of the examination questions having categories and respective values including the category requirements and the value-requirements.

### FIELD OF THE INVENTION

This invention relates generally to examination design, and specifically to using test-suite minimization to select questions for an examination.

### BACKGROUND

Combinatorial Test Design (CTD), also known as combinatorial testing, is an effective software test planning technique, in which the test space is modeled by a set of categories, their respective values, and restrictions on the value combinations. The test space represented by this model is any assignment of one value to each category that does not violate the restrictions. A subset of the space is then automatically constructed so that it covers all valid value combinations (also known as interactions) of every t categories, where t is usually a user input. In other words, for every set of t categories, any combination of t values for them will appear at least once in the test plan (unless there is no valid test that contains it, according to the restrictions).

In general, different levels of interaction can be required for different subsets of categories. The most common application of CTD is known as pairwise testing, in which the interaction of every pair of categories must be covered. Each test in the result of CTD is an assignment of values to all the categories, and represents a high level test, or a test scenario, that needs to be translated to a concrete executable test.

The description above is presented as a general overview of related art in this field and should not be construed as an admission that any of the information it contains constitutes prior art against the present patent application.

### SUMMARY

There is provided, in accordance with an embodiment of the present invention a method, including defining a first number of categories, each of the categories having a respective second number of values, assigning, to each given examination question in a set of examination questions, a respective third number of categories and at least one given value for each of the third number of categories, retrieving a set of requirements, each given requirement including a respective fourth number of category requirements and a respective value-requirement for each of the category requirements, and executing a test-suite minimization algorithm to select a minimum subset of the examination questions having categories and respective values including the category requirements and the value-requirements.

There is also provided, in accordance with an embodiment of the present invention an apparatus, including a storage device configured to store a set of examination questions, and a processor configured to define a first number of categories, each of the categories having a respective second number of values, to assign, to each given examination question in the set of examination questions, a respective third number of categories and at least one given value for each of the third number of categories, to retrieve a set of requirements, each given requirement including a respective fourth number of category requirements and a respective value-requirement for each of the category requirements, and to execute a test-suite minimization algorithm to select a minimum subset of the examination questions having categories and respective values including the category requirements and the value-requirements.

There is further provided, in accordance with an embodiment of the present invention a computer program product, the computer program product including a non-transitory computer readable storage medium having computer readable program code embodied therewith, the computer readable program code including computer readable program code configured to define a first number of categories, each of the categories having a respective second number of values, computer readable program code configured to assign, to each given examination question in a set of examination questions, a respective third number of categories and at least one given value for each of the third number of categories, computer readable program code configured to retrieve a set of requirements, each given requirement including a respective fourth number of category requirements and a respective value-requirement for each of the category requirements, and computer readable program code configured to execute a test-suite minimization algorithm to select a minimum subset of the examination questions having categories and respective values including the category requirements and the value-requirements.

### BRIEF DESCRIPTION OF THE DRAWINGS

The disclosure is herein described, by way of example only, with reference to the accompanying drawings, wherein:

FIG. 1 is a block diagram that schematically illustrates a computer system configured to use a test-suite minimization algorithm to select questions for an examination, in accordance with an embodiment of the present invention; and

FIG. 2 is a flow diagram that schematically illustrates a method of using the test-suite minimization algorithm to select questions for the examination, in accordance with an embodiment of the present invention.

### DETAILED DESCRIPTION OF EMBODIMENTS

With exponential increase in the complexity and sophistication of healthcare systems, it is becoming more essential to constantly improve the skills of healthcare personnel. Accordingly, healthcare practitioners are expected to attend numerous courses throughout their professional lives, and to take numerous professional tests in order to certify their professional skills. Moreover, given the pervasiveness of diagnostic imaging, it is essential to test both clinical knowledge and medical image understanding. For example, radiologists in many countries are expected to initially pass an advanced certification exam and then pass annual recertification exams.

Since patient lives depend on skills of physicians, public demands that tests would be both comprehensive and fair. The bodies that currently administer such tests rely overwhelmingly on manual test preparation, and as a result, the cost of test preparation is quite high. Despite these high costs, the examinations are in many cases criticized for both being unfair and for having questions leaked to the examinees. In fact, one can find “prescription books” offering advice on how to increase the chances of success by analyzing question structure (in cases where examinee does not know the correct answer).

Embodiments of the present invention provide methods and systems for using an interaction-based test suite minimization (ITSM) algorithm test-suite minimization algorithm to select, from a set of examination questions, a minimum subset of the examination questions that satisfy a set of requirements. As explained hereinbelow, ITSM (also referred to herein as a test-suite minimization algorithm) reduces an existing test suite, while preserving its interaction coverage. Similar to CTD, ITSM requires defining categories of the test space and their values, but it does not require defining restrictions between the values. It is then given a test suite, where each test is in the form of an assignment of values to the categories, and selects a subset of the test suite that preserves its t-wise value combinations. Clearly, like other test minimization techniques, ITSM is applicable only when there is an existing test suite that is on the one hand extensive and representative enough so that omissions are not a concern, and on the other hand is too large to run to completion and may contain redundant test cases.

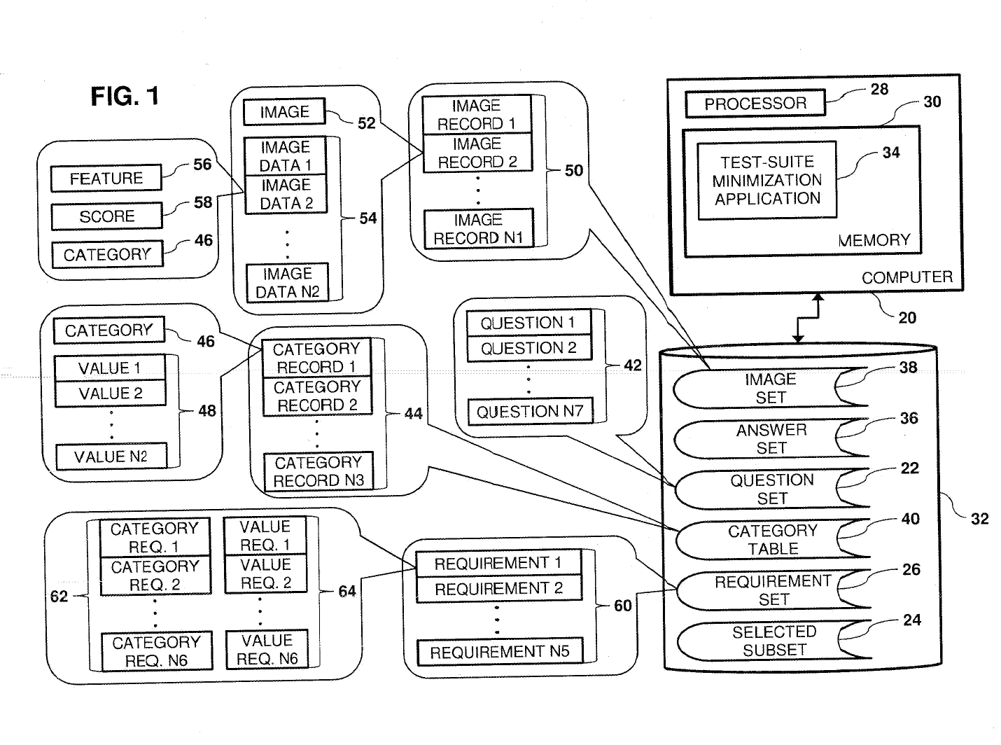

FIG. 1 is a block diagram that schematically illustrates a computer 20 configured to select, from a set of examination questions 22, a subset 24 of the set of the examination questions that meet a requirement set 26, in accordance with an embodiment of the present invention. Computer 20 comprises a processor 28, a memory 30 and a storage device 32. In operation, processor executes, from memory 30, a test-suite minimization application 34 that selects subset 24 based on requirement set 26. Test-suite minimization application 34 implements an ITSM algorithm that is described in an Appendix presented hereinbelow.

Storage device 32 typically comprises a hard disk drive or a solid state disk (SSD) drive that stores question set 22, requirement set 26, selected subset 24, an answer set 36, an image set 38, and a category table 40. Question set 22 comprises multiple examination questions 42, and answer set 36 comprises multiple answers (not shown) for each question 42.

Category table 40 comprises multiple category records 44, each of the category records comprising a respective category 46 and multiple respective values 48. Examples of a given category includes, but is not limited to demographics such as ethnicity, gender, and age range, ailment characteristics such as symptom location and symptom severity, and medical test results. As described supra, each category 46 has multiple respective values 48. For example:
The values for a “gender” category 46 may comprise “male” and “female”.
The values for an “age range” category 46 may comprise “0-10”, “11-20”, “21-40”, “41-60” and “61+”.
The values for an “ailment characteristic” category 46 may comprise “Cardiac”, “Pulmonary”, “Immunological”, “Neurological”, etc.
The values for a “medical test result” category 46 may comprise “white cell count”, “sodium level”, “glucose level”, etc.

In some embodiments, a given category 46 may have multiple sub-categories. For example, given category 46 “ailment” for a patient may have “primary ailment characteristic” and “secondary ailment characteristic” sub-categories.

Image set 38 comprises multiple image records 50, each of the image records comprising an image 52 and multiple image data entries 54. Images 52 may comprise digital images such as X-rays and ultrasounds, and each image data entry comprises a feature 56, a probability score 58 and a given category 46. In embodiments herein, image data entries 54 and their respective features 56, scores 57 and categories 46 may also be referred to as image attributes. Additionally, in some embodiments, each feature may have multiple image values (not shown). For example:
A given feature 56 may comprise “Lesion type”, with possible image values “Malignant”, “Benign” and “Unknown”.
A given feature 56 may comprise “Breast density”, with possible image values “High”, “Medium” and “Low”.
A given feature 56 may comprise “Borders”, with possible image values “Smooth”, “Fuzzy” and “Spiculated”.
A given feature 56 may comprise “Location”, with possible image values “Axilla”, “Fibro-Glandular Tissue”, “Fat Tissue” and “Skin”.
A given feature 56 may comprise “View”, with possible image values “CC” and “MLO”.
A given feature 56 may comprise “Side”, with possible image values “Right” and “Left”.
A given feature 56 may comprise “Difficulty”, with possible image values “Hard”, “Medium” and “Easy”.

In some embodiments, test-suite minimization application 34 may treat image records 50 as “image-based” questions. In other words, based on requirement set 26, selected subset 24 comprises questions 42 that may reference one or more image records 50. For image-based questions, processor 28 can apply test-suite minimization application 34 to create, for each image-based question, a corresponding semantic representation and its associated probability score 58.

For example, for ultrasonic tumor images, computer 20 can automatically provide estimates of relevant diagnostic features (e.g., homogeneity, echogeneicty, border definition, tumor shape, orientation). Each feature 56 can have a given probability use for estimation of the image difficulty. In turn, these features would be used by the computer in order to ensure that exams (i.e., subset 24) are well balanced both in coverage of image features and in terms of image complexity.

Requirement set 26 comprises multiple requirements 60, each of the requirements comprising multiple category requirements 62 and a respective value-requirement for each of the category requirements. Requirements 60 define combinations of category values that should appear in a medical exam. A given requirement 60 can be multiple pairs of category requirements 62 and value-requirements 64 (also referred to herein as category/value pairs. Examples of category/value pairs include:
Lesion type=Malignant, wherein “Lesion type” comprises a given category requirement 62 and “Malignant” comprises a given value-requirement 64.
Breast density=Medium, wherein “Breast Density” comprises a given category requirement 62 and “Medium” comprises a given value-requirement 64.
Borders=Smooth, wherein “Borders” comprises a given category requirement 62 and “Smooth” comprises a given value-requirement 64.

In some embodiments, requirements 60 can be defined by tuples of category/value pairs, such as “all value combinations of any three categories out of Lesion type, Breast density, Location, and View”. Additionally, combinations of the two types of requirements described hereinabove are possible.

Another example of a given requirement 60 would be for a clinical examination definition. For example the requirements may indicate that an examination contains at least one question from each of ten major diseases and at least five questions from a set of twenty less frequent diseases. In other words, requirements 60 may include target numbers for questions covering specific (or combinations of) categories 46. Similarly, requirements 60 can control the choice of category requirements 62 such as patients age, symptoms etc.

In some embodiments, a given category for questions 42 may indicate a question type and a given requirement may indicate a target number of the questions for a given question type. For example, a given requirements 60 can indicate that 10% of the selected questions in subset 33 are of a negative type, 10% would contain Boolean expressions and 80% would be of a positive type.

In additional embodiments, a given category 46 may indicate a difficulty of a given question 42, and a given requirement 60 may contain the notion of exam difficulty defined as a function of image difficulty (one of the image categories), diagnosis frequency, and similarity between the answers. Difficulty measure would be normalized to, say, 1-100. Therefore, by changing the given requirement, an exam proctor can set a difficulty level for an examination.

In further embodiments, questions 42 can be created out of existing hospital records. In operation, processor 28 can retrieve, from a patient's data folder, both clinical information and diagnostic images. Then, using techniques described above, processor 28 can analyze actual field cases in order to create distinct exams covering one or more specific subjects.

In embodiments of the present invention, given a set of requirements, processor 28 can apply a test minimization algorithm (such as the one described in the Appendix hereinbelow), in order to generate an exam comprising subset 24 that satisfies as many of the requirements as possible given the contents of the question and/or the image sets. The algorithm also ensures that the exam is as short as possible—it chooses questions that have a maximal payload with respect to the requirements.

In some embodiments, the question and the image sets may not satisfy all the requirements. For example, there may be a given requirement 60 for a given image 52 that shows a malignant tumor in the axilla, but there may be no such image in the Image set. Application 34 can report such cases, and Combinatorial Test Design may be used to define a minimal set of new entries to the database (i.e., the question and the image sets) that would allow generating exams that satisfy these requirements.

Processor 28 comprises a general-purpose central processing unit (CPU) or special-purpose embedded processors, which are programmed in software or firmware to carry out the functions described herein. The software may be downloaded to computer 20 in electronic form, over a network, for example, or it may be provided on non-transitory tangible media, such as optical, magnetic or electronic memory media. Alternatively, some or all of the functions of the processor may be carried out by dedicated or programmable digital hardware components, or using a combination of hardware and software elements.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

### Examination Generation

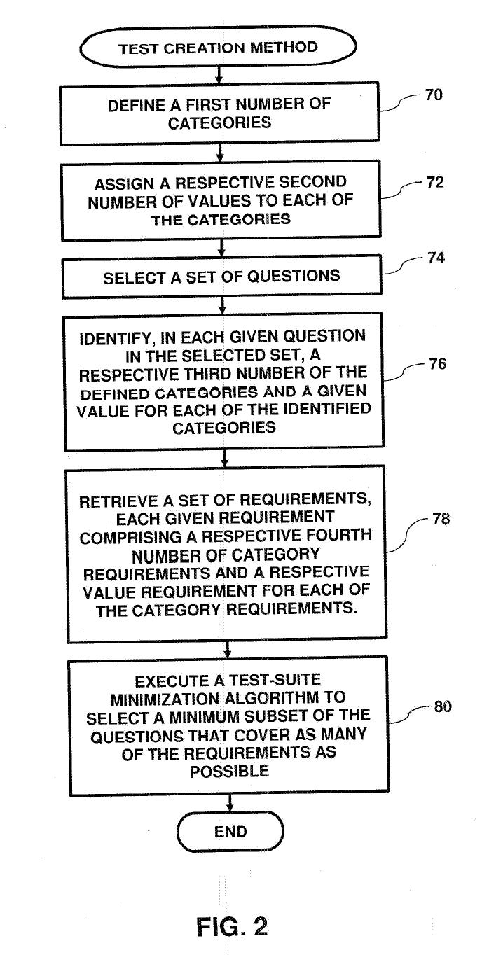

FIG. 2 is a flow diagram that schematically illustrates a method of using a test-suite minimization algorithm to select subset 24 for an examination, in accordance with an embodiment of the present invention. In a definition step 70, processor 28 defines a first number of categories 46, and in an assignment step 72, the processor assigns (i.e., associates) a respective second number (i.e., at least one) of values 48 to each of the categories. In some embodiments, the assignment of values 48 to categories 46 can be performed manually and stored to category table 40, and processor 28 can perform steps 70 and 72 by retrieving the categories and the values from the category table.

In a first selection step 74, processor 28 selects questions set 22 and/or image set 38 whose respective questions 42 and/or images 52 will be used to create an examination. In an identification step 76, processor 28 identifies, for each given question 42, a respective third number of categories 46. In embodiments where images 52 are to be included in the examination, processor 28 identifies one or more categories 46 for each of the images.

In a retrieval step 78, processor 28 retrieves requirement set 26, wherein as described supra, each given requirement 60 in the requirement set comprises a respective fourth number of requirements 60, each of the fourth number of the requirements comprising a given category requirement 62 and a given value-requirement 64. Finally, in a second selection step 80, processor 28 executes the test-suite minimization algorithm in application 34 (as described hereinbelow in the Appendix), which selects subset 24 that comprises the minimum number of questions and/or images 52 that cover as many of requirements 60 as possible, and the method ends. In embodiments of the present invention, subset 24 comprises questions 42 having categories 46 and respective values 48 that comprise (i.e., cover) the category requirements and the value-requirements in requirement set 26.

The flowchart(s) and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX

### Interaction-Based Test-Suite Minimization (Itsm) Algorithm

This appendix presents an implementation of an ITSM algorithm. In embodiments of the present invention, the value combinations that are to be covered are referred to as coverage targets. Coverage targets may be given in different forms, such as a Cartesian product (e.g., “every combination of size t”, just as in standard CTD), or as explicit sets of value combinations to be covered. In embodiments described herein, a test t covers a coverage requirement c if the values specified by c are used in t.

Given a suite of tests T=tᵢ, i=1 . . . n, a set of coverage targets C=cⱼ, j=1 . . . m, and a mapping M:T→2^{C} that specifies the coverage targets that are covered by each test in T, the objective of an interaction-based test-suite minimization algorithm is to find S=sᵢ, i=1 . . . k, a subset of T that covers all the targets that covers—S⊂Ts.t.∪_{i=1 . . . n}M(tᵢ)=∪_{i=1 . . . k}M(sᵢ).

We describe a fast algorithm that uses a low overhead data structure.

First, consider the following simple and greedy algorithm:
For i=1 . . . n, if tᵢ covers a target that is not yet covered by S then add tᵢ to S.

It is easy to see that at the end of the loop, S covers all the targets that T covers. However, it is also easy to see that S is not always the best solution. For example, if the test suite has two tests, the first of which covering one target and the second covering the same target and another one, this algorithm will select both tests, whereas the second test suffices.

This algorithm visits each test in T at most once. Its time complexity is O(|T|·|C|).

The following algorithm is less greedy, produces better results, but works harder:
While S covers less than T, add to S the test that covers the most targets that are covered by T but not yet covered by S.

This algorithm also computes a correct result, that is, in the end S covers the same targets as T does. Its result is not optimal, but it works well for the example above.

This algorithm visits n−i tests in its i-th iteration, hence its time complexity is O(|T|·|C|·|S|). In the worst case, |S|=|T|, but in practice |S| is frequently orders of magnitude less than |T|.

We next explore three ways to improve this algorithm. Two reduce the constant factor in the O( ) complexity expression of this algorithm, and one results in a smaller output test suite.

Avoiding unnecessary calculations.

Test prioritization.

Counting uncovered targets.

Avoiding Unnecessary Calculations:

We introduce an improvement that significantly reduces the number of times that uncovered targets are counted.

Note that the number of uncovered targets that a test can contribute in a single iteration is never higher than the number it could contribute in a previous iteration. Hence, if the current iteration has already found a test that contributes maxSoFar new targets, then the O(|C|) process of counting uncovered targets for any test that could contribute less than maxSoFar in previous iterations can be skipped. This is illustrated in Algorithm 1, where testᵢ.prevCount is the latest computed contribution for testᵢ. Note that this value is not necessarily computed in every iteration.

Algorithm 1: Skipping unnecessary counts

| 1 | if testᵢ.prevCount > maxSoFar then | | |
|---|---|---|---|
| 2 | \| | Compute count, the number of uncovered | |
| | \| | targets that testᵢ covers | |
| 3 | \| | testᵢ.prevCount ← count | |
| 4 | \| | if count > maxSoFar then | |
| 5 | \| | \| | best ← testᵢ |
| 6 | \| | \| | maxSoFar ← count |

| | | |
|---|---|---|
| 7 | \| | end |

| | |
|---|---|
| 8 | end |

Test Prioritization:

Changing the priority of selecting tests results in a smaller output test suite.

So far, we only considered the number of uncovered targets in preferring one test over another. Typically, this results in the algorithm ending with many iterations selecting tests that contribute only one target. We experimented with several weighting schemes that give a higher weight to targets that appear less in the input, and preferring higher weight tests to lower.

The intuition behind this approach is that when such weights are used, the first iterations select tests that cover many hard to find targets, and the last iterations easily find many easy to find targets.

Indeed, using weights may reduce the size of the selected suite by up to 15%.

Counting Uncovered Targets:

Finally, ITSM can be speeded up by performing several bit operations at a time. We maintain a mapping from each test to the targets that it covers. To implement ITSM, covered targets can represented by bits in integer variables, which we call elements, and counting the number of set bits in a bitmap is done using a lookup table for an element at a time. Significant speedup can be obtained by using 16 bit elements—a “short int” in C/C++, or a “char” in Java. Such bitmaps are associated with each input test, representing the targets that each test covers, and are also used for intermediate results, representing the targets that still have to be covered.

Algorithm 2 shows counting the number of uncovered targets that testᵢ contributes. testᵢ.coveredj is the j-th element in the bitmap that describes the targets covered by testᵢ, bitCount[ ] is a lookup table that is initialized to the count of set bits in every possible element, and count is the number of uncovered targets that testᵢ can contribute.

This speedup can be combined with the priority criterion above by using nElementsInBitmap bitCount[ ] tables, i.e., using bitCountⱼ [new] instead of bitCount[new] in line 4 of Algorithm 2.

Algorithm 2: Counting uncovered targets

| 1 | count ← 0 | |
|---|---|---|
| 2 | for j = 0 to nElementsInBitmap do | |
| 3 | \| | new ← testᵢ.coveredⱼ & uncoveredⱼ |
| 4 | \| | delta ← bitCount[new] |
| 5 | \| | count ← count + delta |

| | |
|---|---|
| 6 | end |

1. A method, comprising:
defining a first number of categories, each of the categories having a respective second number of values;
assigning, to each given examination question in a set of examination questions, a respective third number of categories and at least one given value for each of the third number of categories;
retrieving a set of requirements, each given requirement comprising a respective fourth number of category requirements and a respective value-requirement for each of the category requirements; and
executing a test-suite minimization algorithm to select a minimum subset of the examination questions having categories and respective values comprising the category requirements and the value-requirements.

2. The method according to claim 1, wherein the questions comprise medical examination questions.

3. The method according to claim 2, wherein a given category is selected from a group consisting of a demographic of a patient, a characteristic of an ailment, and a medical test result.

4. The method according to claim 1, wherein a given question comprises an image, and wherein each of the categories for the image comprises a feature of the image.

5. The method according to claim 1, wherein the requirements comprise first requirements, and comprising a second requirement comprising a target number of a given first requirement.

6. The method according to claim 1, wherein a given category comprises multiple question types, and wherein a given category for a given examination question comprises a given question type.

7. The method according to claim 6, wherein a given requirement comprises a target number of the examination questions comprising a specific question type.

8. An apparatus, comprising:
a storage device configured to store a set of examination questions; and
a processor configured:
to define a first number of categories, each of the categories having a respective second number of values,
to assign, to each given examination question in the set of examination questions, a respective third number of categories and at least one given value for each of the third number of categories,
to retrieve a set of requirements, each given requirement comprising a respective fourth number of category requirements and a respective value-requirement for each of the category requirements, and
to execute a test-suite minimization algorithm to select a minimum subset of the examination questions having categories and respective values comprising the category requirements and the value-requirements.

9. The apparatus according to claim 8, wherein the questions comprise medical examination questions.

10. The apparatus according to claim 9, wherein a given category is selected from a group consisting of a demographic of a patient, a characteristic of an ailment, and a medical test result.

11. The apparatus according to claim 8, wherein a given question comprises an image, and wherein each of the categories for the image comprises an attribute of the image.

12. The apparatus according to claim 8, wherein the requirements comprise first requirements, and wherein the processor is configured to define a second requirement comprising a target number of a given first requirement.

13. The apparatus according to claim 8, wherein a given category comprises multiple question types, and wherein a given category for a given examination question comprises a given question type.

14. The apparatus according to claim 13, wherein a given requirement comprises a target number of the examination questions comprising a specific question type.

15. A computer program product, the computer program product comprising:
a non-transitory computer readable storage medium having computer readable program code embodied therewith, the computer readable program code comprising:
computer readable program code configured to define a first number of categories, each of the categories having a respective second number of values;
computer readable program code configured to assign, to each given examination question in a set of examination questions, a respective third number of categories and at least one given value for each of the third number of categories;
computer readable program code configured to retrieve a set of requirements, each given requirement comprising a respective fourth number of category requirements and a respective value-requirement for each of the category requirements; and
computer readable program code configured to execute a test-suite minimization algorithm to select a minimum subset of the examination questions having categories and respective values comprising the category requirements and the value-requirements.

16. The computer program product according to claim 15, wherein the questions comprise medical examination questions.

17. The computer program product according to claim 16, wherein a given category is selected from a group consisting of a demographic of a patient, a characteristic of an ailment, and a medical test result.

18. The computer program product according to claim 15, wherein a given question comprises an image, and wherein each of the categories for the image comprises an attribute of the image.

19. The computer program product according to claim 15, wherein the requirements comprise first requirements, and comprising computer readable program code configured to define a second requirement comprising a target number of a given first requirement.

20. The computer program product according to claim 15, wherein a given category comprises multiple question types, and wherein a given category for a given examination question comprises a given question type, and wherein a given requirement comprises a target number of the examination questions comprising a specific question type.
